(19) United States
(12) Patent Application Publication
(10) Pub. No.: US 2002/0016738 A1
(43) Pub. Date: Feb. 7, 2002

(54) Computer system

(76) Inventor: Brantley W. Coile, Athens, GA (US)

Correspondence Address: Law Office of Jerome D. Jackson, 211 N. Union Street, Suite 100, Alexandria, VA, 22314, US

(21) Appl. No.: 09/884,227

(22) Filed: Jun. 20, 2001

Related U.S. Application Data
(60) Provisional application No. 60/214,006, filed on Jun. 26, 2000.

(51) Int. Cl. G06F 17/60; G06G 1/12

(52) U.S. Cl. 705/21; 705/14

(57) ABSTRACT

Disclosed are systems and methods for performing customer checkout transactions by processing customer-selected items with data on customer cards.

### BACKGROUND OF THE INVENTION

This Application claims the benefit of application Ser. No. 60/214,006 of BRANTLEY W. COILE filed Jun. 26, 2000 for COMPUTER SYSTEM, the contents of which are herein incorporated by reference.

1. Field of the Invention

This invention relates generally to a store, and, more particularly, to a computer system configurations and methods for processing discount information in a store.

2. Description of Related Art

Product promotions employing price discounts are a popular means to stimulate sales of products such as grocery store items.

### SUMMARY OF THE INVENTION

It is an object of the present invention to provide a computer system for processing discount information to adjust a price in a purchase transaction.

To achieve this and other objects of the present invention, there is a method in a system including a first process and a plurality of second processes. The method comprises the steps, performed for each second process, of reading a first location from a card via the second process; determining, in the first process, a second location responsive to a content of the first location; and reading the second location from the first card via the second process.

According to another aspect of the present invention, a system comprises a plurality of consumer-held cards. Each card includes a list of value pairs. Each pair includes a signal indicating a length of the pair. One of the pairs includes a discount coupon.

According to yet another aspect of the present invention, a processing system comprises a first processor; and a plurality of second processors, each second processor including circuitry that reads a first location from a card, and reads a second location from the card. The first processor acts to determine the second location responsive to a content of the first location.

According to yet another aspect of the present invention, there is a processing system in a system comprising a first process and a plurality of second processes. The processing system comprises means for reading a first location from a card via a second process in the plurality of second processes; means for determining, in the first process, a second location responsive to a content of the first location; and means for reading the second location from the first card via the second process.

### BRIEF DESCRIPTION OF THE DRAWINGS

FIG. 1 is a view of a building containing a computer system according to a first preferred embodiment of the present invention.

FIG. 2 is a view of a part of a retail store in the building.

FIGS. 3A and 3B are a view of another part of the retail store.

FIG. 4 is a diagram emphasizing a control and data flow in the first preferred system.

FIG. 5 is a flow chart of a process performed in the first preferred system.

FIG. 6 is a diagram of a data structure on a customer card.

FIG. 7 is a diagram of a process performed in the first preferred system.

FIG. 8 is a diagram emphasizing connectivity in the first preferred system.

FIGS. 9A and 9B are a diagram emphasizing a portion of the diagram shown in FIG. 8.

FIG. 10 is a diagram showing a structure of a command between two parts of the first preferred system.

FIG. 11 is a diagram showing a structure of a response between the two parts of the preferred system.

FIG. 12 is a diagram summarizing commands between two parts of the first preferred system.

FIG. 13 is a diagram showing a part of the response structure between the two parts of the preferred system.

The accompanying drawings which are incorporated in and which constitute a part of this specification, illustrate embodiments of the invention and, together with the description, explain the principles and advantages of the invention. Throughout the drawings, corresponding parts are labeled with corresponding reference numbers.

### DESCRIPTION OF THE PREFERRED EMBODIMENTS

First Preferred Embodiment

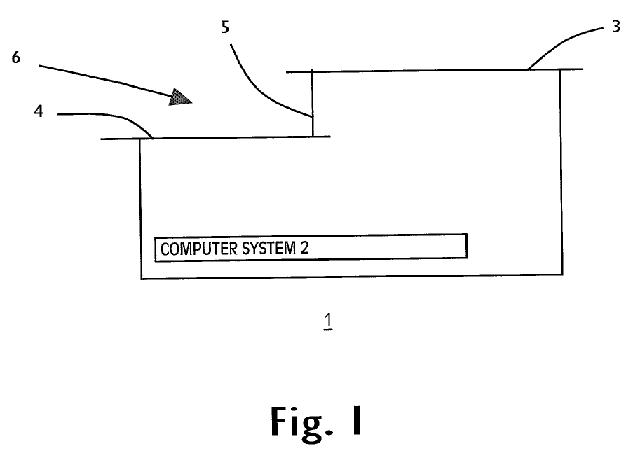

FIG. 1 shows a store 1 including computer system 2 under roof structure 6, in accordance with a first preferred embodiment of the present invention. Roof structure 6 includes roof section 4, window 5 coupled to roof section 4, and roof section 3 coupled to window 5.

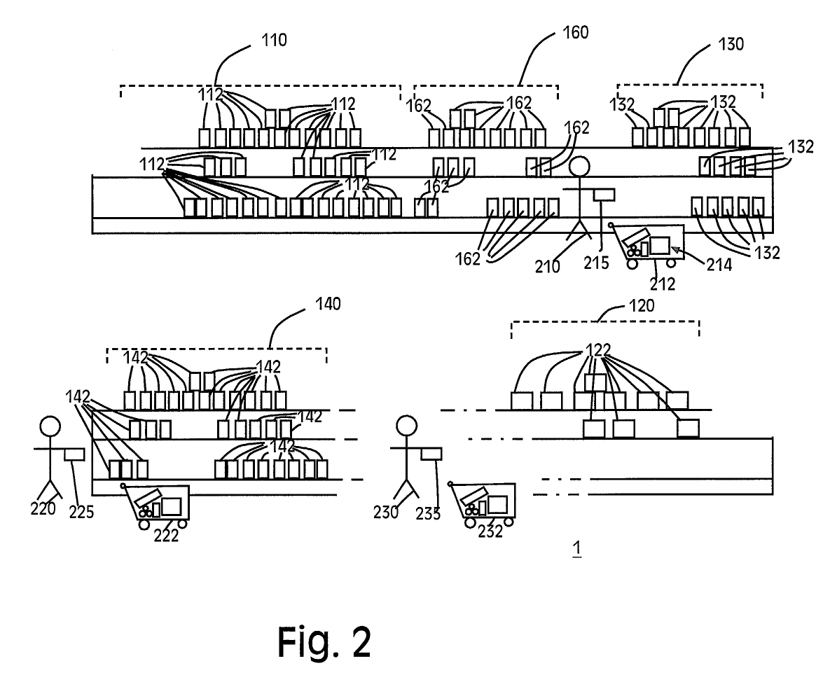

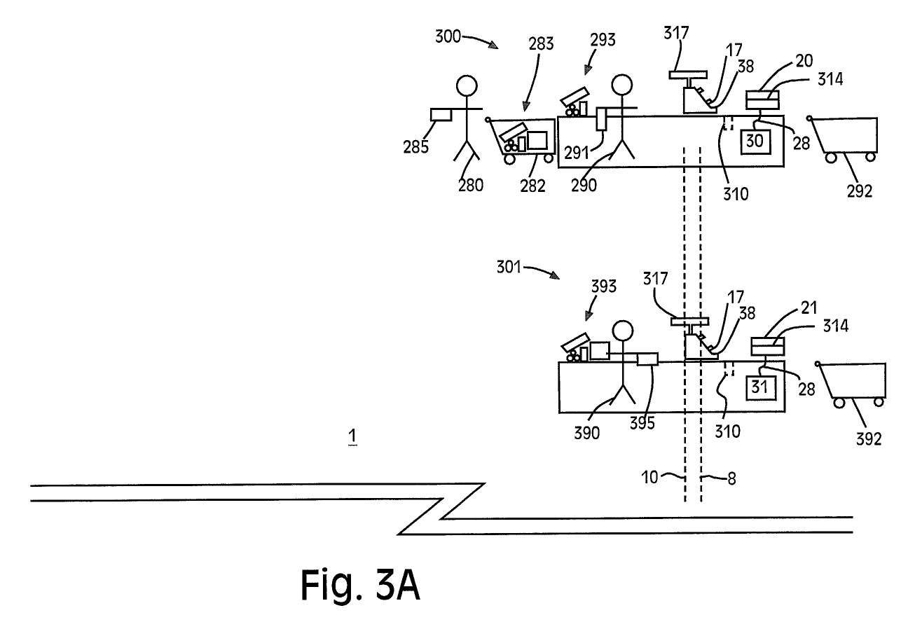

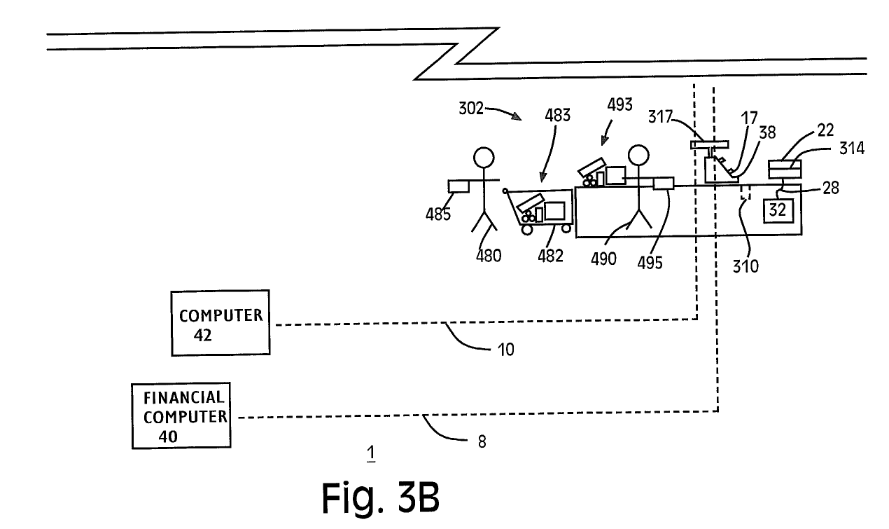

FIGS. 2, 3A, and 3B are each a partial view of store 1. Store 1 has a plurality of product areas, each corresponding to a respective product. For example, product area 110 has bottles 112 of Delta brand detergent. Each bottle of detergent 112 has a common Universal Product Code (UPC) symbol, which is a group of parallel lines encoding a number typically called a “bar code.” This number is part of a product identification system documented by the Uniform Code Council, Inc., Dayton, Ohio. The first digit is a number system character, which in this case is 0. The next five digits are a manufacturer ID. The next 5 digits are an item number. The last digit is a check digit. UPC product code 0 17075 00003 3 uniquely identifies Delta Detergent.

Product area 120 has boxes of pasta 122. Each box of pasta 122 has a common UPC symbol encoding a UPC product code (0 17031 00005 3) uniquely identifying Old World pasta.

Product area 130 has boxes of light bulbs 132. Each box of light bulbs 132 has a common UPC symbol encoding a UPC product code (0 17054 1017 6) uniquely identifying Lighthouse light bulbs.

Similarly, other product areas in store 1 each have a set of respective products contiguously grouped together. Respective units of a certain product have a common UPC symbol, different from UPC symbols on units of other products, that uniquely identifies the certain product. Respective units of a certain product also have a common human readable word label, different from labels on units of other products, that uniquely identifies the certain product with words. Product area 140 has bottles of ABC brand ketchup 142 contiguously grouped together. Product area 160 has loaves of Boxer brand bread 162 contiguously grouped together.

Customers 210, 220, 230, 280, and 290, shop in store 1. Some of the customers, such as customer 210 in FIG. 2, carry an electronic card, such as customer card 215, which is approximately the length and width of a typical financial credit card. While shopping in store 1, each of customers 210, 220, 230, 280, and 290 carries his or her respective customer card. Customer 210 carries card 215, customer 220 carries card 225, customer 230 carries card 235, customer 280 carries card 285, and customer 290 carries card 295. Each customer removes one or more desired products from a shelf and places the removed product into her cart.

Upon completion of shopping, the customer brings selected products from the shelves to checkout station 300, 301, or 302.

Checkout station 300 includes cash register system 30 and card interface system 20. Card interface system 20 communicates with cash register system 30 via serial data cable 28.

Checkout station 301 includes cash register system 31 and card interface system 21. Card interface system 21 communicates with cash register system 31 via serial data cable 28.

Checkout station 302 includes cash register system 32 and card interface system 22. Card interface system 22 communicates with cash register system 32 via serial data cable 28.

A customer may redeem electronic coupons by presenting her customer card for insertion into interface slot 314 of smart card reader/writer 315. For example, referring to FIGS. 2, 3A, and 3B, customer 280 completes the purchase of her selected products 283 by transferring products 283 from her cart 282 to station 300, and by presenting card 285. A checkout clerk (not shown) then scans each product 283 past bar code reader 310, or enters the product selection information manually via keyboard 38, allowing station 300 to generate a UPC product code for the most recently processed product. Using discount information stored on card 285, computer system 2 determines a total amount due and prints the total amount due on display 317 and on the customer's paper receipt.

Similarly, customer 390 completes the purchase of her selected products 393 by transferring products 393 from her cart 392 to station 301, and by presenting card 395; customer 490 completes the purchase of his selected products 493 by transferring products 493 to station 302, and by presenting card 495;customer 480 completes the purchase of his selected products 483 by transferring products 483 from his cart 482 to station 302, and by presenting card 485. Customer 210 completes the purchase of her selected products 214 by transferring products 214 from her cart 212 to station 300, and by presenting card 215; customer 290 completes the purchase of her selected products 293 by transferring products 293 from her cart 292 to station 300, and by presenting card 295 for insertion into card interface slot 314. It is presently preferred that card insertion occur at the beginning of the checkout transaction, although card insertion could happen later.

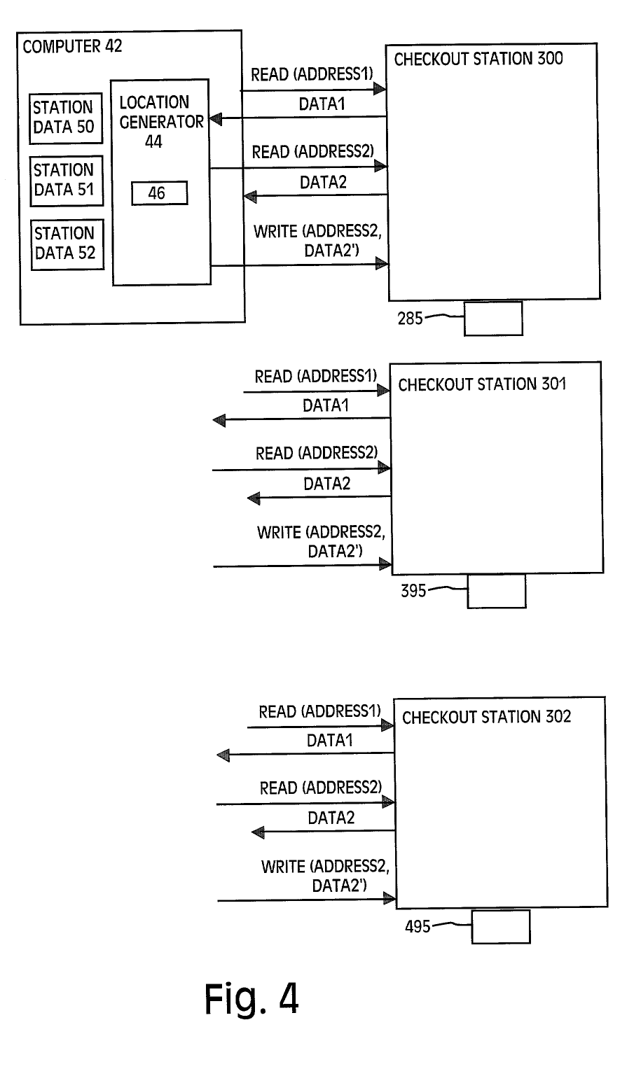

FIG. 4 emphasizes electronic control and data paths within the first preferred system. Computer 42 includes circuitry that correlates respective products selected by a card holder with coupons on the card holder's card. In this Patent Application, the word circuitry encompasses dedicated hardware, and/or programmable hardware, such as a central processing unit (CPU) or reconfigurable logic array, in combination with programming data, such as sequentially fetched CPU instructions or programming data for a reconfigurable array.

Computer 42 can correlate products and coupons for multiple customers performing checkout transactions at respective multiple checkout stations. To preform this correlation, computer 42 includes circuitry for reading and writing data to customer cards and, more specifically, computer 42 has circuitry that controls which card locations to read and write.

For example, at the time depicted in FIG. 4, computer 42 correlates products selected by customer 280, the holder of card 285, with coupons on card 285 in checkout station 300. To perform this correlation, computer 42 controls the reading and writing of data to customer card 285. More specifically, computer 42 directs which locations in card 285 to read and write. Thus, computer 42 may be viewed as containing logic that generates a card location. In FIG. 4, this logic is depicted as location generator circuitry 44. Generator circuitry 44 generates a card location, to be read or written, in response to a previously read card location.

During the checkout transaction for customer 280, computer 42 maintains station data 50. Station data 50 includes data about transactions at checkout station 300, including a list of coupons from card 285 and a list of products selected by the holder of card 285, customer 280.

After computer 42 generates a READ command to read from card locations starting at ADDRESS1, location generator circuitry 44 receives the contents of these locations. These contents are designated DATA1. In this description, the terminology ADDRESS1, DATA1, ADDRESS2, DATA2, etc., designates arbitrary variables and not necessarily a specific location of offset.

In this example, DATA1 includes control information about the data layout on card 285. Using DATA1, location generator circuitry 44 generates card location ADDRESS2 to read, for example, coupon discount data from card 285. Thus, computer 42 generates a READ command to read from card location ADDRESS2, and computer 42 receives the contents of these locations starting at ADDRESS2. These contents are designated DATA2. DATA2 includes a list of coupons from card 285. Computer 42 writes the list of coupons into station data 50.

Subsequently, station 300 sends UPC product codes, of products 283, to computer 42. Responsive to the received product codes, computer 42 sends a discount amount to station 300, to determine a total amount due from customer 280.

Before customer 280 removes her card from station 300 and exists store 1, computer 42 generates a WRITE command to update data on card 285, reflecting coupons expended by redemption, total products purchased to date, etc.

Computer 42 also includes circuitry for communicating with station 301 to perform the identical process described in connection with station 300, for a different customer and card, such as customer 390 and card 395. During the checkout transaction for customer 390, computer 42 maintains station data 51. Station data 51 includes data about transactions at checkout station 301, including a list of coupons from card 395 and a list of products selected by customer 390.

Computer 42 also includes circuitry for communicating with station 302 to perform the identical process described in connection with station 300, for a different customer and card, such as customer 490 and card 495. During the checkout transaction for customer 490, computer 42 maintains station data 52. Station data 52 includes data about transactions at checkout station 302, including a list of coupons from card 495 and a list of products selected by customer 490.

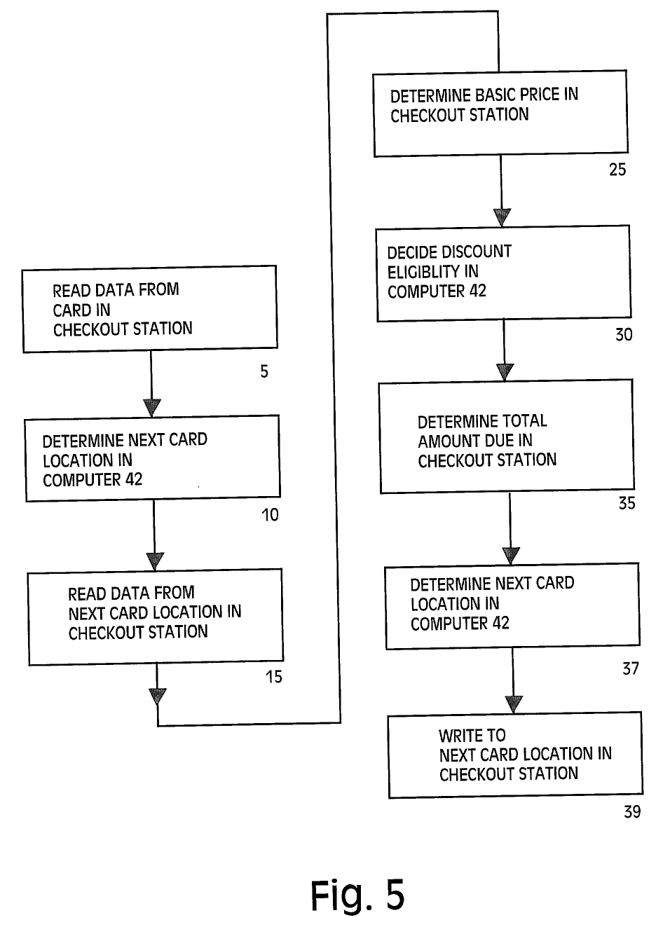

FIG. 5 shows a process performed by computer system 2. The process of FIG. 5 is performed for the checkout transaction of each card holder at each checkout station. Reader/writer 315 reads control data from the card. (step 5). The control data includes information about the architecture of data on the card. Station 300 sends the control data to computer 42.

Computer 42 receives the control data and uses the received control data to calculate a next location for reading from the card. (step 10). Computer 42 sends a card READ command to checkout station 300, to request that the calculated location be read from the card.

Checkout station 300 receives the card READ command from computer 42 and reads the requested location. (step 15). Checkout station 300 sends the content of the read location to computer 42.

A checkout clerk (not shown) scans each selected product past bar code reader 310, or enters the product selection information manually via keyboard 38, allowing station 300 to generate a UPC product code for each product. Station 300 determines a basic price for the product (step 25), and a textual description of the product. Station 300 determines a basic price for the product by processing a pricing information message received from financial computer 40, via cable 8 (FIGS. 3A and 3B). Station 300 sends a signal encoding the textual description of the product to display 317, and display 317 generates a human readable output describing the product.

Computer 42 makes a list of the products selected by the customer. Computer 42 performs electronic coupon redemption, by processing the selected products in the context of the coupon information from the customer's card to determine discount eligibility (step 30).

In response to the results of steps 25 and 30, station 300 determines a total amount due and prints the total amount due on display 317 and on the customer's paper receipt. (step 35).

System 2 writes data to the customer card to mark or delete coupons that are no longer eligible for redemption. More specifically, computer 42 determines a location for writing to the card. (step 37). Computer 42 sends a card WRITE command to checkout station 300, to request that the determined location be written to the card. Checkout station 300 receives the card WRITE command from computer 42 and writes the requested location. (step 39).

Each card bearing customer will complete the purchase of his or her selected products by transferring the selected products to one of stations 300, 301, or 302 and by presenting a respective card for insertion into interface slot 314; and a clerk will scan each selected product past UPC bar code reader 310.

The preferred embodiments of the present invention will now be described in more detail.

Card Data Structure

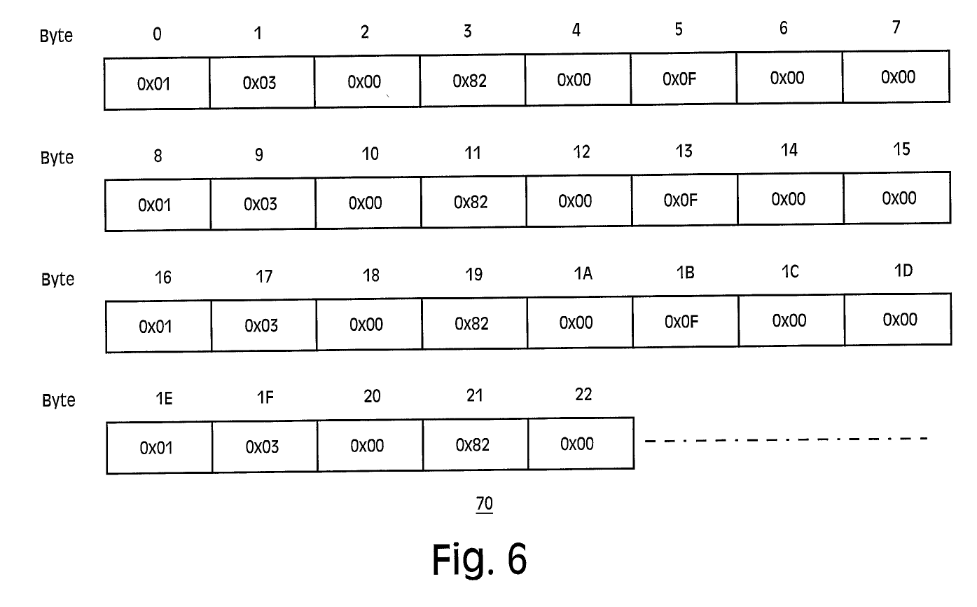

FIG. 6 shows list 70 stored on customer card 285. List 70 is a type of data structure within other data structures on card 285. More specifically, a file structure of card 285 is described in ISO/IEC 7816-4, and is similar to that of DOS and UNIX. List 70 is an elementary file having ID OxOCO7, contained in a dedicated file directly under the master file having ID Ox3FOO.

List 70 includes multiple type/value pairs. Each type has two or three bytes and defines a specific object or value. If bit 15 of the type is 1, the length in bytes of the entire type/value pair is contained in the next 2 bytes. If bit 15 is 0, the length is contained in the next byte. In other words, type values greater than or equal to 0×80 have a two byte length, and type values less than 0×80 have a single byte length. The value consists of whatever data and format is defined for the associated type.

By examining the type, computer 42 determines the meaning of the value data and the length of the type/value pair. Thus, computer 42 may efficiently process list 70. When computer 42 examines an type byte and determines that the type is not of interest, computer 42 advances a data pointer by the length of the type. Computer 42 uses the advanced data pointer to send a READ command to computer 300 to read the next location from card 285.

In the example of FIG. 6, the first type pair is 3 bytes long. Byte 0 is the type byte, and since it is less than 0×80 this first type/value pair has a 1-byte length in byte 1. This first type value pair has a 1-byte value of 0 in byte 2.

The second type/value pair is 15 bytes long. Byte 3 is the type byte, and since it is greater than 0×80 this second type/value pair has a 2-byte length in bytes 4 and 5. This second type/value pair has a 13-byte value in bytes is through 18.

An type of 0×82 identifies a list of discount offers, which are a list of electronic coupons in this embodiment. The first 3 bytes of the value space, of this type value pair, indicates the offset position within the value space of the next available slot for a coupon identifier. The remaining bytes of the value space are coupon identifiers previously loaded onto the card.

Other types of types include card type, with type value 0×01, and a single byte value space indicating a type or version of customer card; customer name, having type ID 0×10, having a variable length value space indicating the name of the card holder; and discount level, having type ID 0×08, with a single byte value space having a code indicating one of multiple discount levels, such as silver, gold, or platinum.

Each of the customer cards has the same basic structure as that of customer card 280.

Processors

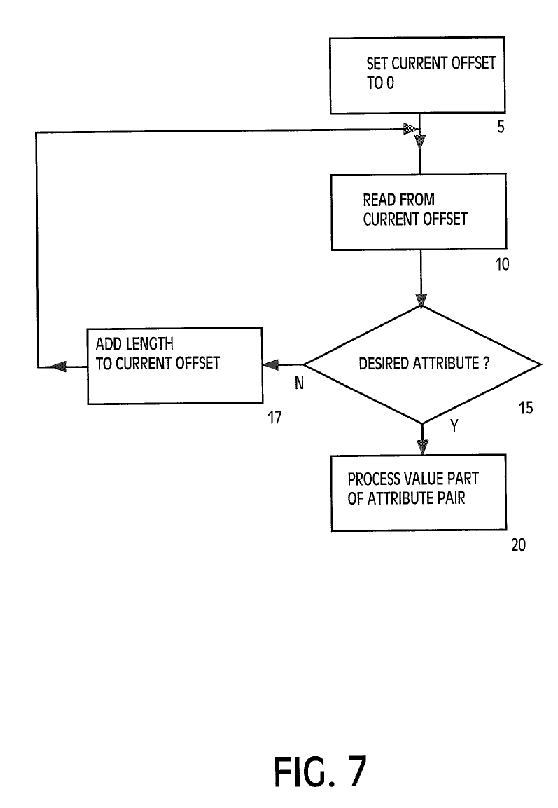

FIG. 7 shows a process performed by location generator 44 of FIG. 4. The processing of FIG. 7 corresponds to that of steps 5-15 of FIG. 5.

Location generator 44 sets address pointer 46 to 0. (Step 5). Location generator 44 uses the current value of address pointer 46 to construct a READ command and send the READ command to checkout station 300 (Step 10).

The first time through the loop of FIG. 7, the processing of step 10 corresponds to sending a READ command to read from ADDRESS 1 described above in connection with FIG. 4.

Generator 44 determines whether the type read in step 10 is the desired type. (Step 15). The first time through the loop, the processing of step 15 corresponds to examining DATA 1 described above in connection with FIG. 4.

If the current type is not the desired type, generator 44 adds the type length to address pointer 46. (Step 17). The processing of step 17 may correspond to constructing a READ command to read from ADDRESS2.

If the type is the desired type, which in this example is 0×82, computer 42 processes the value space of the desired type. (Step 20). Following the example of FIG. 4, the processing of step 20 of FIG. 7 corresponds to writing a coupon list from the value space of the current type into station data 50.

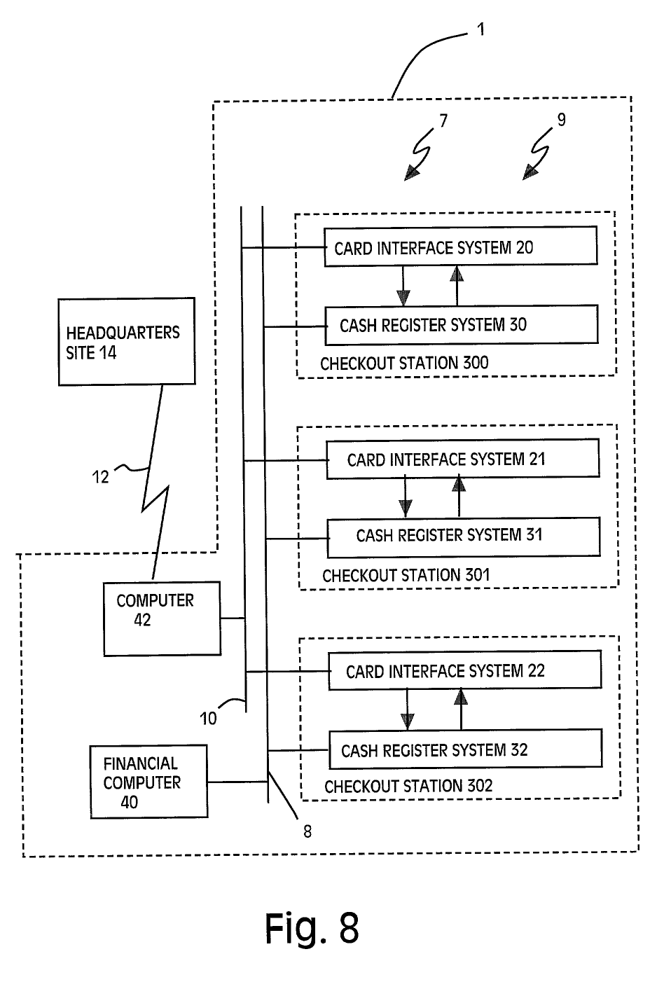

FIG. 8 shows another aspect of the first preferred system. Computer system 2 includes Local Area Network (LAN) 7 and LAN 9 in store 1. LAN 7 includes ethernet cable 8 and 4 computers: financial computer 40, cash register system 30, cash register system 31, and cash register system 32. Cash register system 30 is in checkout station 300, cash register system 31 is in checkout station 301, and cash register system 32 is in checkout station 302. Each of computer 40 and systems 30, 31, and 32 has a respective network address uniquely identifying it in network 7. Each of computer 40 and systems 30, 31, and 32 has circuitry for recognizing when a packet containing its address is sent over cable 8, temporarily storing such a packet, and processing the packet contents when such a packet is recognized.

Computer 40 and systems 30, 31, and 32 communicate by sending data packets in a format conforming to the communication protocol of network 7.

Local Area Network (LAN) 9 in store 1 includes ethernet cable 10 and 4 computers: computer 42, card interface system 20, card interface system 21, and card interface system 22. Card interface system 20 is in checkout station 300, card interface 21 is in checkout station 301, and card interface system 22 is in checkout station 302. Each of computer 42 and systems 20, 21, and 22 has a respective network address uniquely identifying the computer in network 9. Each of computer 42 and systems 20, 21, and 22 has a respective circuitry for recognizing when a packet containing the computer's address is sent over cable 10, temporarily storing such a packet, and processing the packet contents when such a packet is recognized.

Computer 42 and systems 20, 21, and 22 communicate with each other by sending data packets in a format conforming to the communication protocol of network 9.

System 20 compiles basket data, including customer identification data, from a plurality of checkout transactions, and sends the basket data to headquarters site 14, via computer 42, and telecommunications link 12.

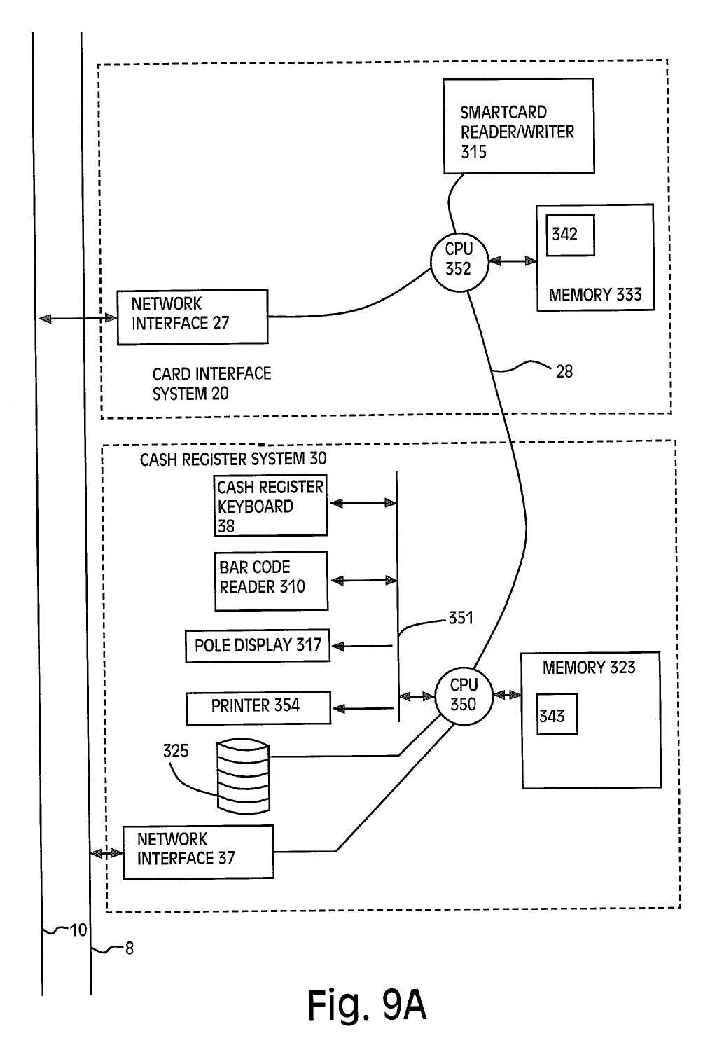

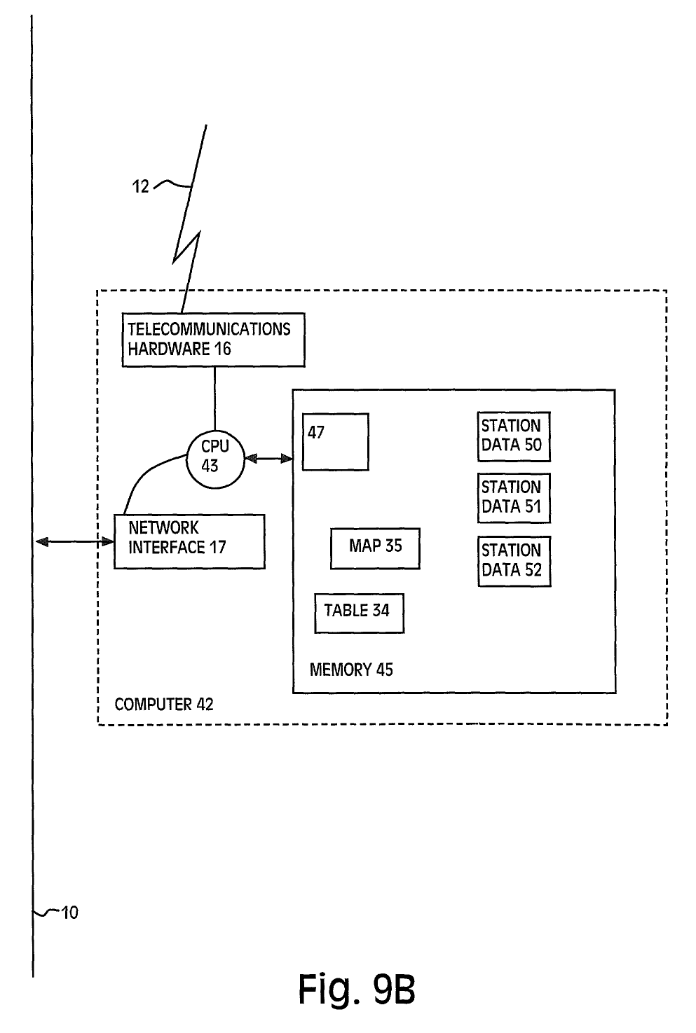

FIGS. 9A and 9B are a block diagram of computer 42 and checkout station 300. Checkout station 300 includes cash register system 30 and card interface system 20. Cash register system 30 includes an IBM 4680-4690 Point of Sale System. CPU 350 send data to, and receives data from cable 8 via network interface 37. CPU 350 executes instructions 343 in random access, addressable memory 323. CPU 350 communicates with cash register keyboard 38, bar code reader 310, pole display 317, and printer 354 via via RS-485 serial bus 351. Cash register keyboard 38 allows manual entry of alpha-numeric-data. Bar code reader 310 generates a bar code signal, and sends the bar code signal to CPU 350. Poll display 317 displays product data in response to signals from CPU 350. Disk 325 provides long term storage.

In card interface system 20, CPU 352 send data to, and receives data from cable 10 via network interface 27. CPU 352 executes program 342 in random access, addressable memory 333. CPU 352 and program 342 act to receive electronic coupons from a customer card, via reader/writer 315.

A physical layer includes an RS-232 asynchronous serial connection on which CPU 350 in system 30 communicates with CPU 352 in system 20 via RS232 line 28.

A data link layer between systems 30 and 20 includes a frame with a start code octet, one or more data octets, a checksum octet, and an end code octet. Every frame transmitted requires an ACK/NAK response. When system 20 receives a frame with a correct checksum, system 20 sends an ACK response; otherwise system 20 sends a NAK response. If system 30 does not receive a response within a reasonable amount of time, system 30 declares a timeout condition and resend the frame.

An application layer between systems 30 and 20 includes a series of commands and responses, as discussed in more detail below.

In computer 42, telecommunications hardware 16 is coupled to site 14 via communications link 12. Hardware 16 may include a modem, PSTN interface circuitry, or T1 connection interface circuitry, for example. Hardware 16 could also be a wireless transceiver for satellite communication, for example.

CPU 43 sends data to, and receives data from, cable 10 via network interface 17.

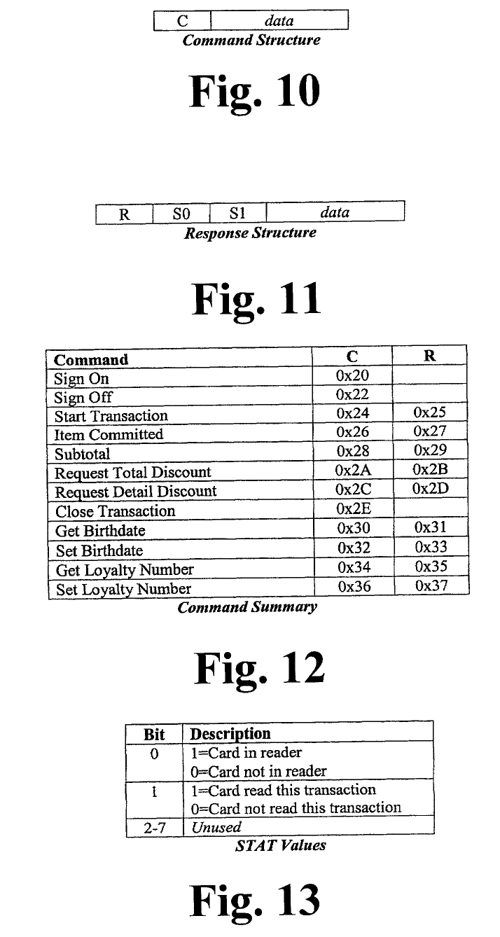

FIG. 10 shows the structure of a command packet including a single command octet followed by 0 or more data octets. Some commands require a response while others do not, as summarized in FIG. 12.

FIG. 11 shows the structure of a response packet including status octets S0 and S1 followed by zero or more data octets. S0 shows the current status of the customer card, and S1 is an error bit mask for the received parameters. The bits in S0 are shown in FIG. 13. Each bit in S1 corresponds to a parameter in the command. A 1 in a bit position of S1 indicates an error condition with the corresponding parameter position. For example, if system 20 receives a command with an invalid value for the second parameter P1, system 20 sends a response with bit 1 of S1 set to one 1.

FIG. 12 summarizes some commands sent from system 30 to system 20 in the application layer supported by the data link layer, which in turn is supported by the physical layer. The Sign On command notifies system 20 of a register sign-on event. Any transaction process in progress is terminated. All counters are cleared and system 20 awaits the next command from register system 30. There are no parameters associated with this command, and there is no response generated.

The Sign Off command notifies system 20 of a register sign-off event. Any transaction process in progress is terminated. All counters are cleared and system 20 awaits the next command from register system 30. There are no parameters associated with this command, and there is no response generated.

The Start Transaction command notifies system 20 of the start of a new transaction. Any transaction in process in progress is terminated. All counters are cleared and system 20 awaits the next command from register system 30.

The Item Committed command notifies system 20 of item committed event. Six parameters for the Item Committed command are described in Table 1 below.

TABLE 1

| | |
|---|---|
| P0 | Item key. Unique identifier assigned by Register and used as part |
| | of the Request Detail Discount response for matching a coupon with |
| | a particular item. (4 digits, packed decimal). |
| P1 | Sales type |

0×30 = Normal Sales
0×31 = Refund/Return
0×32 = Manufacturer Coupon
0×33 = Store Coupon
0×34 = Cancel Normal Sales
0×35 = Cancel Refund/Return
0×36 = Cancel Manufacturer Coupon
0×37 = Cancel Store Coupon

| | |
|---|---|
| P2 | Item code. (12 digits, packed decimal). |
| P3 | Extended price. (4 digits, packed decimal). |
| P4 | Quantity. (3 digits, packed decimal). |
| P5 | Weight. (6 digits, packed decimal). |

The Subtotal command notifies system 20 of the current subtotal amount in parameter P0. Receiving this command causes system 20 to calculate the discount data based on the Item Committed commands received during this transaction. Therefore, this command must precede the Request Total Discount and Request Detail Discount commands. There is no response associated with this command.

The Request Total Discount command requests system 20 to return the total coupon discount. This command has 2 response parameters: R0—number of coupons representing total discount, and R1—total discount amount.

The Request Detail Discount command requests system 20 to return the first or next coupon depending on the value of P0, with P0=0 representing the first coupon and P0=any other amount representing the next coupon. A response where R0-R2 are all zeroes indicates the end of the coupon list. Otherwise, response parameters R0-R5 include, respectively, item key, item code, value code, offer index, expiration code, and amount.

The Close Transaction command notifies system 20 of the end of the current transaction. Any transaction process in progress is terminated. All counters are cleared and system 20 awaits the next command from register system 30. There is no response associated with this command.

It is presently preferred that sending of commands from system 30 be implemented by customizing system 30 with a “user exits,” which are a standardized mechanism by which the IBM 4860-4690 system calls custom routines, as described in the IBM 4680-4690 Supermarket Application: Programming Guide, SC30-3634, Third Edition (January 1997). Some exits employed in this customization may include TSUPEC2—After a Customer Checkout Transaction is Completed, and TSUPEC14—After Reading the Keyboard/Scanner, and TSUPEC23—Before Writing a Line to the Display.

When system 20 receives an application layer command from system 30, system 20 sends the command to computer 42. In response to receiving a command, computer 42 sends any needed response to system 20, and system 20 then sends the response to system 30.

In computer 42, CPU 43 executes instructions 47 in random access, addressable memory 45. Memory 45 stores redemption control table 34, which enables CPU 43 to determine if a customer-selected product has a corresponding electronic promotion. Redemption control table 34 is essentially a list of promotions. Memory 45 also stores map 35, which associates card coupon IDs with promotion ID in table 34.

When computer 42 receives an Item Committed command identifying a product selected by a customer at station 300, computer 42 adds the product to a basket list in station 50.

When computer 42 receives a Subtotal command, computer 42 selects each product in the basket list and searches for the selected product code in UPC product code fields of redemption control table 34, thus enabling computer 42 to determine if the product has a corresponding electronic promotion.

If the product does have an electronic promotion, computer 42 translates the promotion number from table 34 to a card coupon ID, using map 35. Computer 42 then searches the card coupon list in station data 50 to confirm that the customer has the corresponding coupon ID on her card. If the customer has the corresponding coupon ID on her card and the qualifier conditions are satisfied, the coupon quantity is added to a variable TOTAL_DISCOUNT_AMOUNT.

Thus, processing of a subtotal command, iterates through each combination of coupon and customer-selected product stored in station data 50. Essentially, this iteration is performed with products changing in an outerloop and coupons changing in an innerloop.

Some low level processing performed by CPU 352, executing program 342, will now be described in more detail. CPU 352 communicates with a card in interface slot 314 through smart card reader/writer hardware 315. A switch (not shown) in interface slot 314 alerts reader/writer 315, which alerts CPU 352, that a card has been inserted into the slot. Subsequently, CPU 352 causes smart card reader/writer 315 to reset the card. The card then answers the reset by sending an “answer to reset” data block in accordance with the ISO standard ISO 7816-3: 1989 (E).

A communication protocol between reader/writer hardware 315 and a customer card is described in more detail in ISO 7816-3: 1989 (E), Identification cards—Integrated circuit(s) cards with contacts—Part 3: Electronic signals and transmission protocols; and ISO 7816-3: 1989/Amd.1: 1992 (E), Part 3: Electronic signals and transmission protocols, AMENDMENT 1: Protocol type T=1, synchronous half duplex block transmission protocol. Both of these standards are promulgated by the International Organization for Standardization (ISO) and distributed by the American National Standards Institute (ANSI).

Various parts of the components shown in random access memory 323 may be transferred between memory 323 and disk memory 325 using a virtual memory mapping scheme, as is well known in the art.

Checkout stations 301 and 302 each have the same circuitry as that of as checkout station 300.

A customer may start shopping with a card already loaded with electronic coupons. For example, the store may preload new cards as an incentive for completing and submitting a check cashing application. The customer may receive a pre-loaded card from a kiosk as described in U.S. Pat. No. 5,956,694 of Ken R. Powell issued Sep. 21, 1999 for SYSTEM AND METHOD FOR DISTRIBUTING AND PROCESSING DISCOUNT COUPONS, Ser. No. 08/799,691, Feb. 11, 1997, the contents of which is herein incorporated by reference. The customer may also have a device at home for loading coupons onto the card, as described in U.S. Pat. No. 5,806,044 of KEN R. POWELL issued Sep. 8, 1998 for SYSTEM AND METHOD FOR DISTRIBUTING COUPONS THROUGH A SYSTEM OF COMPUTER NETWORKS, Ser. No. 08/603,482, filed Feb. 20, 1996, the contents of which is herein incorporated by reference. The customer may also load coupons onto the card from in-store shelf units, as described in copending U.S. patent application of KEN R. POWELL for RETAIL SYSTEM, Ser. No. 08/468,816, filed Jun. 6, 1995, the contents of which is herein incorporated by reference. An in-store unit may write a coupon, onto the card, in the form of a shelf-unit ID code, the ID code being associated with different discount offers from time to time, as described in U.S. patent application of BRANTLEY W. COILE, KEVIN W. HARTLEY, and ELEANOR B. MAXWELL for SYSTEMS AND METHODS OF CONFIGURING STORES FOR PRODUCT PROMOTION, Ser. No. 09/469,256, filed Dec. 22, 1999, the contents of which is herein incorporated by reference.

Although the exemplary embodiments show computer 42 controlling card access based on a length field, embodiments of the invention may be practiced with various other types of access control from a common computer. For example, a common computer may decide to selectively process certain records or card fields based on contents of previously read records. Card data structures need not include the exemplary type/value pair list.

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims.

What is claimed is:

1. In a system including a first process and a plurality of second processes, a method comprising the steps, performed for each second process, of:
reading a first location from a card via the second process;
determining, in the first process, a second location responsive to a content of the first location; and
reading the second location from the first card via the second process.

2. The method of claim 1 wherein the content of the first location includes a length.

3. The method of claim 1 wherein the content of the first location includes a value characteristic.

4. The method of claim 1 wherein the content of the first location includes a version ID.

5. The method of claim 1 wherein each second process is located in a respective checkout station.

6. The method of claim 1 wherein each second process is located in a respective checkout station and the method further includes sending a financial signal from the first process to the checkout station.

7. The method of claim 6 wherein sending includes sending to the second process.

8. The method of claim 1 further including sending a signal identifying a product from the checkout station to the first process.

9. The method of claim 1 wherein the system further includes a third process, each located in a respective checkout station, and the method further includes sending a financial signal from the first process to the third process.

10. The method of claim 9 wherein sending includes sending via the second process.

11. A system comprising a plurality of consumer-held cards, each card including a list of value pairs, each pair including a signal indicating a length of the pair, one of the pairs including a discount coupon.

12. A processing system comprising:
a first processor; and
a plurality of second processors, each second processor including circuitry that reads a first location from a card, and reads a second location from the card, wherein the first processor acts to determine the second location responsive to a content of the first location.

13. The processing system of claim 12 wherein the content of the first location includes a length.

14. The processing system of claim 12 wherein the content of the first location includes a value characteristic.

15. The processing system of claim 12 wherein the content of the first location includes a version ID.

16. The processing system of claim 12 wherein each second processor is located in a respective checkout station.

17. The processing system of claim 12 wherein each second processor is located in a respective checkout station, and the first processor acts to send a financial signal to the checkout station.

18. The processing system of claim 17 wherein the first processor acts to send the financial signal to the second processor.

19. The processing system of claim 12 wherein the first processor includes circuitry that receives a signal identifying a product.

20. The processing system of claim 12 wherein the system further includes a third processor, each located in a respective checkout station, and the first processor acts to send a financial signal to the third processor.

21. In a system including a first process and a plurality of second processes, a processing system comprising:
means for reading a first location from a card via a second process in the plurality of second processes;
means for determining, in the first process, a second location responsive to a content of the first location; and
means for reading the second location from the first card via the second process.

22. The processing system of claim 21 wherein the content of the first location includes a length.

23. The processing system of claim 21 wherein the content of the first location includes a value characteristic.

24. The processing system of claim 21 wherein the content of the first location includes a version ID.

25. The processing system of claim 21 wherein each second process is located in a respective checkout station.

26. The processing system of claim 21 wherein each second process is located in a respective checkout station and the processing system further includes sending a financial signal from the first process to the checkout station.
